(19) United States
(12) Patent Application Publication
(10) Pub. No.: US 2006/0024481 A1
(43) Pub. Date: Feb. 2, 2006

(54) Jet printing of patterned metal

(75) Inventors: Gary L. House, Victor, NY (US); Richard P. Szajewski, Rochester, NY (US); Mark E. Irving, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/902,205

(22) Filed: Jul. 29, 2004

(51) Int. Cl. B32B 15/00

(52) U.S. Cl. 428/209

(57) ABSTRACT

An article comprising a substrate and a patterned electrically conductive metal phase, wherein the electrically conductive metal phase is selectively deposited on the substrate via sequential or simultaneous ink jetting of combinations of a reducible soluble metal salt, a reduction catalyst and a reducing agent. On substrates having layered structures, the selectively deposited electrically conductive metal phase is intertwined with the substrate microstructure. A method of forming the same is also provided. In a particular embodiment of the method, the selective deposition of the electrically conductive phase onto the substrate comprises a first jetting of a composition comprising the reducible soluble metal salt and the reduction catalyst in a predetermined area followed by a subsequent jetting of a composition comprising the reducible metal salt and the reducing agent over the same predetermined area.

### FIELD OF THE INVENTION

This invention relates to articles and methods of in-situ formation of electrically conductive members using ink jet technology.

### BACKGROUND OF THE INVENTION

Recent commercial interest in electronically driven display devices and particularly in flexible electronically driven display devices has given rise to ongoing efforts in the efficient manufacture of micro electronic circuits by jetting of conductive materials onto suitable substrates.

In a traditional ink jet printer, the printer uses piezoelectric technology (or thermal bubble jet) to squirt ink droplets from a nozzle having a small opening. There are usually four ink cartridges and four nozzles enabling the printer to print four different colors simultaneously. As the printer head scans the page and the piezoelectric materials are pulsed (or bubbles are created thermally in bubble jet), ink is squirted or drops are ejected by volume displacement in bubble jet from the nozzle onto the receiving material. The printer cartridges can alternatively be filled with other compositions, allowing the printer to deposit materials besides inks.

Henniger et al., U.S. Pat. No. 4,736,704 deposits pre-formed solder masking to a circuit board using an inkjet like technique while Drummond et al., U.S. Pat. No. 5,132,248 describes the direct deposition of colloidal suspensions of metals to a substrate followed by thermal annealing to form conductive structures. Both of these methods are deficient in that vigorous and inconvenient methodology is required to form true conductive phases. Sturm et al., U.S. Pat. No. 6,087,196 describes the jetting of a conductive polymer to form organic light emitting diodes and other semiconductor devices. In all three cases, a pre-formed, conductive material is deposited en mass to form conductive phases on a support. The surface deposited phase is not integral to the substrate and can suffer short useful life due to delamination.

In related art, the in situ formation of silver deposits (pictures) by jetting deposition of metal salts and reducing agents are described alternatively by: Oelbrandt, et al. in U.S. Pat. No. 5,621,448; by Sambucetti and Seitz, in IBM Technical Disclosure Bulletin vol. 20, pages 5423-4 (1978); by Leenders, et al. in U.S. Pat. No. 5,621,449; by Mansukhani in U.S. Pat. No. 4,266,229; by Leenders, et al. in U.S. Pat. No. 5,501,150; by Anderson, et al. in U.S. Pat. No. 3,906,141; and by Simpson in “Digital Silver” in Digital Pro, pages 6-8 1997. While these images are integral, the single deposition step described fails to produce continuous conductive phases. More recently, Irving and Szajewski in U.S. Pat. Nos. 6,197,722, 6,143,693 & 6,440,896 describe the formation of dye images by jetting reducing agents and silver ion sources onto pre-treated imaging supports to form dye images in the presence of only catalytic quantities of metal. They are, of course, non-conducting.

These prior art methods employ complex vapor deposition and/or spin coating techniques and thus are limited in materials choices and productivity, by the energy requirements of high temperature processes, and by the complexities of patterning, masking or etching techniques. Accordingly, there remains a need for integral and mechanically stable conductive phases that are made from simple compositions and methodologies using mild conditions on flexible substrates.

### SUMMARY OF THE INVENTION

These heretofore unmet needs are provided by an article comprising a substrate and on said substrate an electrically conductive phase produced in situ by depositing on the substrate in a predetermined pattern a reducible soluble metal salt, a reduction catalyst and a reducing agent suitable for reducing the soluble metal salt in the presence of the reduction catalyst. A preferred embodiment of the article comprises depositing the reducible metal salt more than once, depositing the reducing agent more than once or depositing the reduction catalyst more than once.

These unmet needs are further provided by a method of forming a patterned conductive phase on a receiver by depositing in a predetermined pattern on the receiver a reducible metal salt, a reduction catalyst and a reducing agent, wherein the reducible metal salt is deposited more than one time. Preferably the reducible soluble metal salt and the reduction catalyst are applied followed by application of the reducible soluble metal salt and a reducing agent.

The invention provides an efficient means to create a featured micro device or an advanced microcircuit on a variety of substrates. The article and method can be adaptable to continuous jetting and thus enable high printing productivity and low cost on a variety of substrates. It employs a simple chemical reduction step and thus can be performed at reduced temperatures while enabling the creation of homogeneous regions of conducting metal. Further, when applied to a substrate having solution permeable micro fibrous networks with connected interstitial regimes collectively defining internal connectivity channels, the inventive structure that forms within the structurally defined internal connectivity channels is truly intertwined with the substrate and is not subject to delamination defects.

### DETAILED DESCRIPTION OF THE INVENTION

According to the invention predetermined patterned regions of electron conducting metal (electrically conductive phase) are created via the depositing, preferably jetting, onto a substrate combinations of a soluble metal salt (soluble metal ion), a catalytic site for metal reduction (reduction catalyst), and a reducing agent. The soluble metal salt is preferably the cationic form of copper, silver, gold, nickel, palladium, platinum, zinc, or aluminum, and most preferably silver. It may also include mixtures of these salts. Salts of gallium, germanium or silicon can also be employed. The reduction catalyst is preferably a pre-formed metal cluster, and more preferably Carey Lea Silver. The reducing agent can be an organic or an inorganic reducing agent. Reducing agents are well known to those skilled in the art. Examples of useful organic reducing agents are an optionally substituted hydroquinone, aminophenol, phenylenediamine, ascorbic acid, phenidone, alkyl hydrazine, and aryl hydrazine. The preferred reducing agent is a mixture of bis (p-N-methylaminophenol) sulfate, and hydroquinone. The above components are preferably in a carrier vehicle and may be in the form of a solution, a dispersion or an emulsion. Preferably, each of the above components is contained in a different carrier vehicle so that each component may be applied separately. It is preferred that each carrier vehicle is contained in a distinct reservoir. The carrier vehicle is preferably water or a volatile organic fluid. Most preferably, each of the soluble metal salt, reduction catalyst and reducing agent are in a separate aqueous solution. The carrier vehicle may also comprise a humectant, a viscosity-adjusting agent, a surfactant, pH adjusting agents, and stabilizers, all as known in the art. One or more of the solutions can further comprise a dopant, such as salts of gallium, germanium, silicon, boron or phosphorous to impart semiconductive properties to a formed phase. Binders can be used in the carrier vehicles to promote the adherence or penetration of fluids and in-situ conducting phases to the substrates. Binder choices will depend on the specific characteristics of the substrate. For example, fluoro-surfactants can be used for vinyl-like materials.

The carrier and components described above may be used with any of the components of a traditional ink jet ink composition. The type of carrier composition will depend on the type of ink jet printer that the carrier composition will be printed with. It is well known in the art that drop-on-demand printheads and continuous printheads each require ink compositions with a different set of physical properties in order to achieve reliable and accurate jetting of the ink composition.

In one embodiment of the invention, the carrier composition of the invention is aqueous-based and contains water and water-miscible organic compounds referred to in the art as humectants, co-solvents, penetrating agents, etc. Such compounds are used to prevent the carrier composition from drying out or crusting in the nozzles of an ink jet printhead, to aid solubility of the components in the carrier composition, or facilitate penetration of the carrier composition into a recording element after printing. Representative examples of such organic compounds typically used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, glycerol, 2-methyl-2,4-pentanediol, 1,2,6-hexanetriol, 2-ethyl-2-hydroxymethyl-1,3-propanediol, 1,5-pentanediol, 1,2-hexanediol, and thioglycol; (3) lower mono- and di-alkyl ethers derived from the polyhydric alcohols; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol. For example, typical aqueous-based carrier compositions useful in the invention may contain, relative to the total weight of the carrier composition, water at 20-95 weight % and one or more water-miscible organic compounds at 5-40 weight %.

Other components present in typical aqueous-based ink compositions include surfactants, defoamers, biocides, buffering agents, conductivity enhancing agents, anti-kogation agents, drying agents, waterfast agents, chelating agents, water soluble polymers, water dispersible polymers, inorganic or organic particles, light stabilizers, or ozone stabilizers, all of which are well known in the art of ink jet printing.

The exact choice and amount of carrier components will depend upon the printing system (printer, printhead, etc.) that the carrier composition will be printed with. Important physical properties are viscosity and surface tension. For typical aqueous-based inks, and thus for the carrier composition, acceptable viscosities are no greater than 20 cP, and preferably in the range of about 1.0 to 6.0 cP; and acceptable surface tensions are no greater than 60 dynes/cm, and preferably in the range of 28 dynes/cm to 45 dynes/cm.

When jetted from an ink jet-printing engine, a proper selection of solutions of soluble metal salts, reduction catalysts, preferably ultra fine pre-formed metal catalysts, and metal ion reducing agents added in certain printing combinations surprisingly resulted in the spontaneous formation of conducting metal regions on the receiving substrate. The reducible soluble metal salt, the reduction catalyst and the reducing agent are preferably applied from distinct reservoirs by ink jet printing, using piezo, thermal or stream technology as know in the art. These components are preferably applied from an ink or carrier solution as described above. For example, in one embodiment, solutions of AgNO₃, CLS (Carey Lea Silver), and KRX (Kodak Rapid X-ray) B&W developing agent were found to produce, readily and efficiently, both uniform and patterned regions when jetted with certain solution sequencing schemes.

In one embodiment, the reducible metal salt, the reducing agent or the reduction catalyst is deposited more than one time. Each may be deposited one, two, three, or up to 25 times. They do not need to be deposited the same number of times. It is particularly preferred that the soluble metal salt is deposited more than one time. The components may be deposited in any order. The deposition of soluble metal ion solution either followed by or deposited simultaneously with the reducing agent produced metal formation, however, the more efficient method to produce the conducting phase appears to be one wherein the reduction catalyst is present for the soluble metal ion reduction. In one embodiment the reduction catalyst is deposited first, followed by the simultaneous deposition of both the soluble metal salt and the reducing agent more than one time over the previously applied catalytic sites. In another embodiment the deposition comprises applying the reducible soluble metal salt and reduction catalyst in one step and subsequently again applying the reducible soluble metal salt and a reducing agent. Both sequential and simultaneous deposition, in any combination, (e.g., from C, M, and Y channels of an ink jet printer) of solutions may be utilized although simultaneous jetting of some of the solutions is preferred for a variety of reasons including metal yield on the substrate and the avoidance of registration issues for fine feature creation. The micro feature dimensionality was limited only by the droplet sizes related to the printing head and solutions used.

While surfactants such as Surfynol 465 can be employed in the practice of the invention it is preferred, for the purpose of creating the most efficient conducting metal phase, to omit surfactants from the various solutions utilized in the jetting experiments. Further, it is preferred to utilize the reducible soluble metal salt in the concentration range of between 0.001 molar and 10 molar, and more preferably of at least 0.50 molar. It is also preferred to utilize the reducing agent in the concentration range of between 0.001 molar and 10 molar, and more preferably in the amount of at least 1.0 molar. Finally the reduction catalyst can be supplied in the concentration range of up to 1 molar preferably in the range of 0.001 to 0.1 molar and more preferably in the range of 0.01 to 0.05 molar.

Substrates useful in the practice of this invention can be uniform or layered. Substrates having layered structures are those with purposeful or adventitious depthwise distinctions in microstructure, composition, physical or chemical properties. Substrates having uniform structures lack purposeful or adventitious depthwise distinctions in microstructure, composition, physical or chemical properties. Useful substrates include plain papers, porous receivers, swellable receivers, plastics, metals, and such. These substrates can be pretreated with conductive, semi-conductive or non-conductive layers or paints. The substrates can be rigid or flexible. Preferably the substrate is flexible. Especially useful substrates are those having solution permeable micro fibrous networks with connected interstitial regimes collectively defining internal connectivity channels.

It is expected that conductive metal phases formed in situ on the substrate by the present inventive process will tend to have a residual filamentary character as opposed to conductive metal phases formed by traditional metal deposition techniques, which tend to have a more solid and smooth character. This topographical difference should be independent of the substrate characteristic.

In one embodiment, the invention comprises an article comprising a substrate comprising a permeable phase integrated with a conductive metal phase in a predetermined pattern. In another embodiment the invention comprises an article comprising a substrate and on said substrate a conductive metal phase in a predetermined pattern, wherein said conductive metal phase is intertwined with the preexisting substrate microstructure. When the chosen substrate has solution permeable micro fibrous networks with connected interstitial regimes collectively defining internal connectivity channels, the conductive phase forms in situ partially within the structurally defined internal connectivity channels to form an integral conductor. This integral conductor differs from prior art conductors formed by conventional macroscopic deposition techniques such as spin coating, jetting, painting, sputtering or imagewise erosion of preformed phases as in the lithographic arts, in that these earlier techniques form conductive, semi-conductive or insulative regimes having homogeneous and layered structures subject to mechanical delamination defects. The inventive structures are truly intertwined with the substrate and not subject to delamination. Microscopic examination of such inventive structures reveals formed metallic appearing regimes that visually appear to have been formed so as to fill the preexisting interstitial voids and channels and to encase adventitious preexisting fibrous structures.

A useful patterned conductive phase can be formed on a non-permeable substrate by depositing in a predetermined pattern on said substrate a reducible metal salt, a reduction catalyst and a reducing agent, wherein the reducible metal salt is deposited more than one time. Here, the formed conductive phase can appear to have a rough, inhomogeneous look with high deposition areas dictated, it is believed, by the initial random deposition of reduction catalyst.

In one embodiment the components are jetted using a traditional ink jet printer, the printer using thermal bubble jet technology to squirt ink droplets from a nozzle having a small opening. There are usually four ink cartridges and four ink channels enabling the printer to print four different solutions simultaneously, if desired. As the printer head scans the page the fluid is heated with an electrical pulse creating bubbles that eject the ink or carrier solutions drop-wise from the nozzle onto the receiving material.

The following examples are intended to illustrate, but not to limit, the invention.

### EXAMPLES

TABLE I
Reactant Compositions
Table I describes the compositions of the reactant solutions
used in the examples below. Quantities are in grams.

| | | | | CLS | | |
|---|---|---|---|---|---|---|
| Solution ID | KRX | DEG | AgNO3 | (warmed) | DW | Total |
| 1 | 0 | 2 | 18 | 0 | 0 | 20 |
| 2 | 0 | 2 | 0 | 1 | 17 | 20 |
| 3 | 18 | 2 | 0 | 0 | 0 | 20 |

KRX is Kodak Rapid X-ray Developer. KRX is prepared by adding to 500 gm distilled water 72 gm sodium sulfite, 5 gm bis (p-N-methylaminophenol) sulfate, 10 gm hydroquinone, 35 gm sodium meta borate, 5 gm potassium bromide, 3.5 gm solid sodium hydroxide, and 10 ml of a 0.1 weight % solution of potassium iodide. Once mixed, the pH is then adjusted to 10.36 with a 1 N sulfuric acid or sodium hydroxide solution. DEG is diethylene glycol. AgNO3 is 1.0 molar in silver. CLS is Carey Lea Silver dispersion, comprising 148 g/kg gelatin and 0.46 mol/kg nanoparticulate silver metal nuclei suspended in water at pH 6.2 and pAg 7.9. Finally, DW is distilled water. All units are in grams including the total in the last column. Solutions were used at room temperature (23 degrees C.) except for the CLS solution that was warmed to melt the dispersion.

These solutions were loaded into empty ink cartridges appropriate for use in the cyan (C), magenta (M), and yellow (Y) or black (K) channels of a Canon S520 ink jet printer. The printer was configured with cartridges such that the C, M, Y, and K channels were empty or contained cartridges loaded with various combinations of the reactant solutions. Simple targets were used to create a composite image that was made up from selected simultaneous or sequential (by printing onto the same image area from the same or different channel while passing the media through the printer for more than one printing iteration) drop ejections of the Y, M, C, and K channels of the printer. This target produced both macro- as well as micro-areas of image subject to the smallest drop size available with this printer—about 5 picoliters for C, M, and Y and about 17 picoliters for K. Printing was onto plain paper and Kodak Picture Paper (photoglossy, swellable ink jet paper) substrates. Conductivity measurements at various points within the printed image area were made with a volt-ohmmeter twenty-four hours and one week after the image was created to insure complete drying of the metallic phase and substrate.

Table II describes the various printing combinations used and the results of the individual experiments.

TABLE II
printing combinations and image conductivity assessment

| | | | | | Media type/ | | |
|---|---|---|---|---|---|---|---|
| | Reactant | Reactant | Reactant | Reactant | number of | | Conductivity - |
| | solution | solution | solution | solution | media passes | | measured |
| Printing | in Y | in M | in C | in K | through the | Image | one week |
| Combination | channel | channel | channel | channel | printer | characteristics | after printing |
| A1 | None | None | None | 1 | Photoglossy | No image | None |
| Soluble silver salt | | | | | and plain | observed | |
| solution only - K | | | | | paper/1 or | | |
| has much larger | | | | | more passes | | |
| drop volume than | | | | | | | |
| Y, M, and C | | | | | | | |
| channels | | | | | | | |
| B2 | 3 | 2 | 1 | None | Photoglossy | Faint black | None |
| All 3 solutions in | | | | | and plain | image | |
| an attempt to | | | | | paper/1 or 2 | | |
| produce process | | | | | passes | | |
| black (Y, M, C) | | | | | | | |
| with smallest drop | | | | | | | |
| sizes | | | | | | | |
| C3 | 2 for | 1 | None | None | Photoglossy | Light | None for |
| Soluble silver salt | first | | | | and plain | yellowish | either image |
| and metal catalyst | media | | | | paper/2 | image with 1^{st} | |
| for 1^{st} pass, soluble | pass; | | | | passes total | media pass; | |
| silver salt and | replaced | | | | | light | |
| reducing agent for | with 3 | | | | | yellowish- | |
| 2^{nd} pass | for 2^{nd} | | | | | black image | |
| | media | | | | | with 2^{nd} pass | |
| | pass | | | | | | |
| D4 | None | None | None | 1; then | Photoglossy | Very faint | None |
| Soluble silver salt | | | | followed | paper and | black image | |
| followed by | | | | by 3 | plain paper/2 | | |
| reducing agent in | | | | | passes | | |
| same channel (K) - | | | | | | | |
| large drop volumes | | | | | | | |
| E5 | None | 2 | 1 | None | Plain paper/2 | Very faint | None |
| Soluble silver salt | | | | | passes | yellow image | |
| and metal catalyst | | | | | | | |
| F6 | None | 3 | 1 | None | Plain paper | Very dark | Yes |
| Inventive | | | | | image created | black image | |
| | | | | | in E5 used in | | |
| | | | | | this printing/ | | |
| | | | | | 6 additional | | |
| | | | | | passes jetting | | |
| | | | | | soluble silver | | |
| | | | | | salt and reducing | | |
| | | | | | agent | | |
| G7 | None | 2 | 1 | None | Photoglossy | Faint yellow | None |
| Soluble silver salt | | | | | paper/2 | | |
| and metal catalyst | | | | | passes | | |
| H8 | None | 3 | 1 | None | Image created | Very dark | Yes |
| Inventive | | | | | in G7 used in | black image | |
| | | | | | this printing; | | |
| | | | | | 3 additional | | |
| | | | | | passes jetting | | |
| | | | | | with soluble | | |
| | | | | | silver salt and | | |
| | | | | | reducing | | |
| | | | | | agent | | |

As can be seen from the table, the A1 and B1 results show that neither the silver salt solution jetted by itself or a simple combination of the three reactant-solutions jetted simultaneously for one pass (one target printing) were sufficient to create a contiguous phase of conductive silver. As in the case of C3, jetting silver nitrate and CLS simultaneously and following these solutions with a jetting of KRX (the reducing agent) and CLS on a second pass did not achieve the conducting phase. In the case of D4 (where CLS was not used), simply jetting silver nitrate followed by KRX was insufficient to create the conducting phase, even using the largest drop volumes. In E5 (CLS+soluble silver salt), where no reducing agent was used, only a faint yellow image characteristic of CLS was observed. In other words, there was no spontaneous reduction of silver nitrate by CLS in the absence of a reducing agent.

F6 represents an inventive combination in that the substrate was “preconditioned” by jetting both the silver nitrate and CLS simultaneously as in E5, followed by additional passes of the media through the printer where additional silver nitrate and the reducing agent where jetted simultaneously onto this previously-created “pre-image”. G7 is similar to E5 except that photoglossy ink jet paper was used. H8, an inventive combination, utilizes the faint yellow image created by simultaneous addition of silver nitrate and CLS as created in G7. The three additional passes of this image through the printer with simultaneous addition of KRX and silver nitrate again gave a surprisingly efficient formation of an electrically conductive layer of silver.

It is believed that the simultaneous addition of all three reactants (as in B2) utilizing many substrate passes through the printer would also generate the conducting phase. It was difficult to attempt this experiment as the wetted substrates fouled the printer paper drive mechanisms and smudged the image area. Of course with a stationary substrate, good drying conditions, and an x-y (two dimensions) printing head it is believed that this would be achievable by varying the number of times the solutions were put onto the same area.

The invention has been described in detail with particular reference to certain preferred embodiments thereof, but it will be understood that variations and modifications can be effected within the spirit and scope of the invention.

1. An article comprising a substrate and on said substrate an electrically conductive metal phase produced in situ by depositing on the substrate in a predetermined pattern a reducible soluble metal salt, a reduction catalyst and a reducing agent suitable for reducing the soluble metal salt in the presence of the reduction catalyst.

2. The article of claim 1 wherein said soluble metal salt is the cationic form of copper, silver, gold, nickel, palladium or platinum or mixtures thereof.

3. The article of claim 1 wherein said soluble metal salt is the cationic form of silver.

4. The article of claim 1 wherein said reduction catalyst is a pre-formed metal cluster.

5. The article of claim 1 wherein said reduction catalyst is Carey Lea Silver.

6. The article of claim 1 wherein said reducing agent is an organic reducing agent.

7. The article of claim 1 wherein said reducing agent is an inorganic reducing agent.

8. The article of claim 1 wherein said reducing agent is an optionally substituted hydroquinone, amino phenol, phenylenediamine, ascorbic acid, phenidone, alkyl hydrazine, or aryl hydrazine.

9. The article of claim 1 wherein at least one of the reducible soluble metal salt, reduction catalyst or reducing agent is supplied as a solution, dispersion or emulsion in a carrier vehicle.

10. The article of claim 9 wherein said carrier vehicle further comprises at least one of a humectant, a viscosity-adjusting agent and a surfactant.

11. The article of claim 9 wherein said carrier vehicle is chosen from water or a volatile organic fluid.

12. The article of claim 1 wherein the reducible metal salt is deposited more than one time.

13. The article of claim 1 wherein the reducing agent is deposited more than one time.

14. The article of claim 1 wherein the reduction catalyst is deposited more than one time.

15. The article of claim 1 wherein the deposition comprises applying the reducible soluble metal salt and the reduction catalyst in one step and subsequently again applying the reducible soluble metal salt and a reducing agent.

16. The article of claim 1 wherein said reducible soluble metal salt, said reduction catalyst and said reducing agent are applied in at least two distinct carrier vehicles supplied from at least two distinct reservoirs.

17. The article of claim 1 wherein said reducible soluble metal salt, said reduction catalyst and said reducing agent are applied from distinct carrier vehicles supplied from distinct reservoirs.

18. An article comprising a substrate comprising a permeable phase integrated with a conductive metal phase in a predetermined pattern.

19. An article comprising a substrate and on said substrate a conductive metal phase in a predetermined pattern, wherein said conductive metal phase is intertwined with the preexisting substrate microstructure.

20. The article of claim 19 wherein the conductive metal phase comprises a conductive metal chosen from the group consisting of copper, silver, gold, nickel, platinum, palladium, zinc, aluminum, gallium, germanium and silicone.

21. A method of forming in situ a patterned conductive metal phase on a receiver by depositing in a predetermined pattern on said receiver a reducible soluble metal salt, a reduction catalyst and a reducing agent, wherein the reducible metal salt is deposited more than one time.

22. The method of claim 21 wherein the reducing agent is deposited more than one time.

23. The method of claim 21 wherein the reduction catalyst is deposited more than one time.

24. The method of claim 21 wherein the deposition comprises applying the reducible soluble metal salt and the reduction catalyst in one step and subsequently again applying the reducible soluble metal salt and a reducing agent.

25. The method of claim 21 wherein said reducible soluble metal salt, said reduction catalyst and said reducing agent are applied in at least two distinct carrier vehicles supplied from at least two distinct reservoirs.

26. The method of claim 21 wherein said reducible soluble metal salt, said reduction catalyst and said reducing agent are applied from distinct carrier vehicles supplied from distinct reservoirs.

27. The method of claim 21 wherein said depositing is by ink jet printing.

28. The method of claim 21 wherein said reducible soluble metal salt is supplied from a carrier vehicle as a solution, emulsion or dispersion.

29. The method of claim 28 wherein said reducible soluble metal salt is supplied in the concentration range of between 0.001 molar and 10 molar.

30. The method of claim 21 wherein said reduction catalyst is supplied from a carrier vehicle as a solution, emulsion or dispersion.

31. The method of claim 30 wherein said reduction catalyst is supplied in the concentration range of up to 1 molar.

32. The method of claim 21 wherein said reducing agent is supplied from a carrier vehicle as a solution, emulsion or dispersion.

33. The method of claim 32 wherein said reducing agent is supplied in the concentration range of 0.01 molar and 10 molar.

34. The article of claim 1 wherein said receiver is a flexible receiver.

35. The method of claim 21 wherein said receiver is a flexible receiver.

36. The method of claim 21 wherein said reducible soluble metal salt is the cationic form of copper, silver, gold, nickel, palladium or platinum or mixtures thereof.

37. The method of claim 21 wherein said reducible soluble metal salt is the cationic form of silver.

38. The method of claim 21 wherein said reduction catalyst is a pre-formed metal cluster.

39. The method of claim 21 wherein said reduction catalyst is Carey Lea Silver.

40. The method of claim 21 wherein said reducing agent is an organic reducing agent.

41. The method of claim 21 wherein said reducing agent is an inorganic reducing agent.

42. The method of claim 21 wherein said reducing agent is an optionally substituted hydroquinone, amino phenol, phenylenediamine, ascorbic acid, phenidone, alkyl hydrazine, or aryl hydrazine.

43. The method of claim 21 wherein at least one of the reducible soluble metal salt, reduction catalyst or reducing agent further comprises at least one of a carrier vehicle, a humectant, a viscosity-adjusting agent and/or a surfactant.

44. The method of claim 21 wherein the deposition comprises applying the reducible soluble metal salt and the reduction catalyst in one step and subsequently again applying the reducible soluble metal salt and a reducing agent; wherein said soluble metal salt is the cationic form of silver; said reduction catalyst is Carey Lea Silver; and said reducing agent is an optionally substituted hydroquinone, amino phenol, phenylenediamine, ascorbic acid, phenidone, alkyl hydrazine, or aryl hydrazine.

45. The article of claim 1 wherein the reduction catalyst is deposited first, followed by the simultaneous deposition of both the soluble metal salt and the reducing agent more than one time over the previously applied reduction catalyst.

46. The method of claim 21 wherein the reduction catalyst is deposited first, followed by the simultaneous deposition of both the soluble metal salt and the reducing agent more than one time over the previously applied reduction catalyst.
